(19) United States
(12) Patent Application Publication
(10) Pub. No.: US 2007/0219801 A1
(43) Pub. Date: Sep. 20, 2007

(54) System, method and computer program product for updating a biometric model based on changes in a biometric feature of a user

(76) Inventors: Prabha Sundaram, Sunnyvale, CA (US); Clifford Tavares, San Carlos, CA (US)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/375,970

(22) Filed: Mar. 14, 2006

(51) Int. Cl. G10L 21/00

(52) U.S. Cl. 704/270

(57) ABSTRACT

Embodiments of a system, method and computer program product are described for updating a biometric model of a user enrolled in a biometric system based on changes in a biometric feature of the user. In accordance with one embodiment, a user is authenticated based on an analysis of a first biometric sample received from the user. Features extracted from the first biometric sample may be compared to a first model generated using a second biometric sample obtained from the user at enrollment as well as to a second model generated using a previously authenticated third biometric sample to determine whether the features more closely match the second model than the first model. If the features more closely match the second model than the first model, then the first and second models can be updated based on the extracted features.

### TECHNICAL FIELD

Embodiments described herein relate generally to biometrics, and more particularly to adaptation in biometric verification applications, especially speaker verification systems and methods.

### BACKGROUND

Verification (also known as authentication) is a process of verifying the user is who they claim to be. A goal of verification is to determine if the user is the authentic enrolled user or an impostor. Generally, verification includes four stages: capturing input; filtering unwanted input such as noise; transforming the input to extract a set of feature vectors; generating a statistical representation of the feature vector; and performing a comparison against information previously gathered during an enrollment procedure.

Speaker verification systems (also known as voice verification systems) attempt to match a voice of a speaker whose identity is undergoing verification with a known voice. Speaker verification systems help to provide a means for ensuring secure access by using speech utterances. Verbal submission of a word or phrase or simply a sample of an individual speaker's speaking of a randomly selected word or phrase are provided by a claimant when seeking access to pass through a speaker recognition and/or speaker verification system. An authentic claimant is one whose utterance matches known characteristics associated with the claimed identity.

To train a speaker verification system, a claimant typically provides a speech sample or speech utterance that is scored against a model corresponding to the claimant's claimed identity and a claimant score is then computed to confirm that the claimant is in fact the claimed identity.

Conventional speaker verification systems typically suffer in terms of relatively large memory requirements, an undesirable high complexity, and an unreliability associated with each of the first conventional method and the second conventional method to perform speaker verification. For example, in many speaker verification systems, Hidden Markov Models (HMM) are used to model speaker's voice characteristics. Using Hidden Markov Models, however, may be very expensive in terms of computation resources and memory usage making Hidden Markov Models less suitable for use in resource constrained or limited systems.

Speaker verification systems implementing vector quantization (VQ) schemes, on the other hand, may have low computation and memory usage requirement. Unfortunately, vector quantization schemes often suffer from a drawback of not taking into account the variation of a speaker's voice over time because typical vector quantization schemes represent a “static-snapshot” of a person's voice over the period of an utterance.

Further, the human voice can be subject to change for a variety of reasons such as the mood (e.g., happy, sad, angry) of the speaker and the health of the speaker (e.g., illness). A speaker's voice may also change as the speaker ages. Regardless the reason, in speaker recognition applications, such voice changes can cause failures in the application of voice recognition algorithms. As a result, it may be desirable to develop voice biometrics algorithms that would be able to adapt to or learn from changes in a speaker's voice.

### SUMMARY

Embodiments of a system, method and computer program product are described for updating a biometric model of a user enrolled in a biometric system based on changes in a biometric feature of the user. In accordance with one embodiment, a user is authenticated based on an analysis of a first biometric sample received from the user. The first biometric sample may be compared to a first model and a second model. If the first biometric sample more closely matches the second model than the first model, then the first and second models can be updated based on the features of the first sample. The first model is generated using a second biometric sample obtained from the user at enrollment, and the second model is generated using a previously authenticated a third biometric sample.

Embodiments may be implemented where the biometric samples comprise speech. The models may also be implemented so that they each comprise a codebook so that the comparing can be performed utilizing vector quantization. A data store may be provided to store the updated models.

In one embodiment, the comparing can include comparing distortion calculated between the features and the first model to the distortion calculated between the features and the second model. In such an embodiment, the distortions can be calculated during the authenticating of the user.

Embodiments may also be implemented where the updating includes re-computing centroids of the models based on distortions of the features from each centroid. The updating may also include applying a confidence factor to the models.

The comparison may be implemented in one embodiment by measuring the dissimilarity between the features and the first model and dissimilarity between the features and the second model. The first biometric sample may also be analyzed to ascertain information about repeating occurrences of the features in the first biometric sample. The information about repeating occurrences of features occurring in the first biometric sample can then be compared with information about repeating occurrences of the features in at least one previous version of the biometric sample known to have been made by the user. Based on the comparison of repeating occurrences, a penalty may be assigned to the measured dissimilarity. In such an implementation, the updating of the models may further include adjusting the information about repeating occurrences of the features in the at least one previous version of the biometric sample known to have been made by the user by a factor based on the information about repeating occurrences of the features in the first biometric sample.

### BRIEF DESCRIPTION OF THE DRAWINGS

FIG. 1 is a schematic block diagram of an exemplary biometric system capable of performing incremental training in accordance with an embodiment;

FIG. 2 is a schematic block diagram illustrating an exemplary architecture for implementing an adaptation process in an illustrative speech-based biometric system;

FIG. 3 is a flowchart of an exemplary adaptation process in accordance with an illustrative speech-based embodiment;

FIG. 4 is a schematic block diagram of an illustrative verification system architecture capable of utilizing pattern checking in accordance with one embodiment;

FIGS. 5A and 5B show a flowchart of a biometric system training process that involves pattern checking in accordance with one embodiment;

FIG. 6 is a flowchart of a verification process capable of using pattern checking in accordance with one embodiment; and

FIG. 7 is a schematic process flow diagram for implementing a verification system architecture using pattern checking in accordance with one embodiment.

### DETAILED DESCRIPTION

In general, embodiments of a system, method and computer program product are described for adapting a biometric data (e.g., a biometric model) of a user (i.e., an enrollee) enrolled with a biometric system to changes in the enrollee's particular biometrics used in the biometric system. For example, using embodiments described herein, a speaker recognition system may be implemented that can adapt the voiceprint of a speaker enrolled with the system to track changes in the speaker's voice over time. The amount of change in the voiceprint may depend, for example, on the nature of voice changes detected in the speaker's voice. The embodiments described herein may be useful in helping to improve a biometric recognition system by helping to reduce the “false rejection rate” (FRR) of the system to help the avoid the burden of frequent re-enrollments of an enrollee into a biometric system due to changes in the enrollee's biometric feature/characteristic.

In general, vector quantization systems typically use a what is known as a codebook. During training, the codebook may be populated with entries that encode the distinct features of a speaker's voice. Once trained, the vector quantization system may then be used to verify a speaker's identity. Features from a speaker claiming to be a valid person (the “claimant”) may be compared against the pre-trained codebook. If the claimant is determined to be a close match to a corresponding entry in the code book, the identity of the speaker is verified. Conversely, if the claimant is determined not to be a close match, the claimed identity of the speaker is rejected. In general, embodiments of the adaptation process may be carried out as follows (in the context of a speech-based system): First, a user enrolls with the biometric system by providing a voice sample (e.g., an utterance) to generate voiceprint. This voiceprint can then be stored as a base voiceprint. When the user subsequently attempts verification, the his voiceprint can be updated if verification is successful. The updated voiceprint may be stored as a tracking voiceprint. The base and the tracking voiceprint may be used together used to determine the identity of the user. As the user's voice changes over time, the tracking voiceprint may be used to record changes in the persons voice allowing the verification algorithm to adapt and learn from the user's voice.

### Biometric System

In general, incremental training may be used as a mechanism by which biometric data of user enrolled in a biometric system (i.e., an enrollee or genuine user) may be adapted to changes in the enrollee's biometric feature (e.g., a characteristic) over time. For example, incremental training may be used in a speaker verification system to adapt a voiceprint of an enrollee to changes in the enrollee's voice as the enrollee ages. On each successful verification cycle (i.e., a verification event where the claimant is determined to be genuine (i.e., the claimed enrollee) by the biometric system), the enrollee's biometric data (e.g., an enrollment voiceprint) may be adapted using the biometric sample (e.g., a speech sample) captured from the claimant for verification. Thus, incremental training can be considered a tracking and adaptation technique for helping a biometric system to adjust for changes in the enrollee's biometric feature over time. For purposes of describing the embodiments herein, a biometric may refer to a physical or behavioral characteristic (e.g., voice, fingerprint, iris, physical appearance, handwriting) of a life form such as, for example, a human.

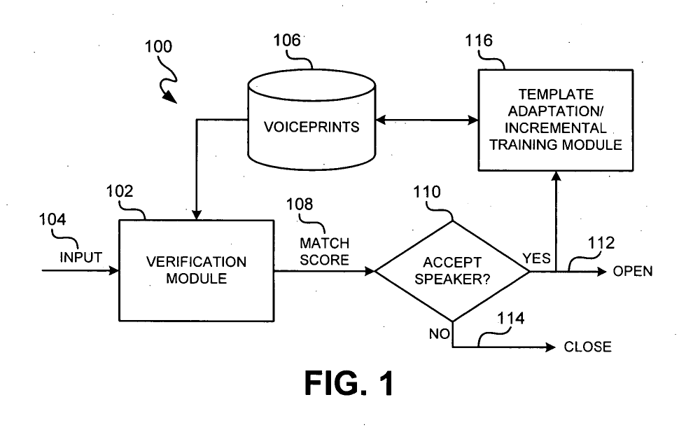

FIG. 1 illustrates an exemplary biometric system 100, more specifically, a speaker recognition (e.g., verification) system, capable of performing incremental training. The biometric system 100 may include a verification module 102 capable of performing a biometric verification process for comparing biometric data from a claimant claiming an identity to biometric data known to have come from the identity (e.g., biometric data from an enrollee of the biometric system) to confirm (i.e., verify) whether the claimant is really the claimed identity.

As shown in FIG. 1, a biometric sample 104 (in this case, a sample of speech) from the claimant claiming an identity of a user enrolled with the biometric system (i.e., an enrollee) may be received as input 104 by the verification module 102 of the biometric system 100. From the input sample 104, features may be extracted by the verification module 102. In a speech-based implementation, the verification module 102 may perform feature extraction using standard signal processing techniques known to one of ordinary skill in the art. It should be noted that prior to feature extraction, the input speech sample 104 may be preprocessed to remove noise, gain control and so on. This preprocessing may be performed before the sample 104 is received by the verification module 102 (e.g., by some sort of preprocessing component) or by the verification module 102 itself. In one implementation, the input speech sample 104 may comprise continuous speech of a short duration between, for example, approximately about 0.2 seconds and about 4.0 seconds.

The biometric system 100 may also include a data store 106, such as a database, for storing biometric data associated with users (i.e., enrollees) enrolled in the biometric system 100. The data store 106 may be coupled to the verification module 102 so that the verification module 102 can access biometric data stored in the data store 106 for comparison (i.e., during the biometric verification process) to features extracted from the input sample 104. In a speech-based implementation, the data store 106 may store one or more voiceprints, with each voiceprint representing a unique voice signature of an enrollee of the biometric system 100. A voiceprint may be generated, for example, during an enrollment process and/or an adaptation process performed by the biometric system 100.

Based on the comparison of the extracted features from the input sample 104 of the claimant to the biometric data of the enrollee (e.g., a voiceprint), the verification module 102 may output a match score 108 representing a degree of similarity or, conversely, a degree of dissimilarity between the compared data.

A decision module may be included in the biometric system 100 for deciding whether to accept the claimant as the claimed identity (i.e., accept the claimant as “genuine”). The decision module 110 may be coupled to the verification module 102 so that the decision module 110 may receive the match score 108 from the verification module 102. The decision module 110 may be capable of converting the output match score 108 into a confidence score and/or a “Yes/No” decision for deciding whether to accept the claimant as the claimed identity. As shown in FIG. 1, if the decision module 110 outputs a “Yes” decision (as represented by the “Yes” path 112), then the claimant may be accepted as the claimed identity (i.e., an “open” state). On the other hand, if the decision module 110 outputs a “No” decision (as represented by the “No” path 114), then the claimant's claim to being the claimed identity may be rejected (i.e., an “closed” state) and the claimant thus determined to be an imposter (i.e., not the claimed identity).

The biometric system 100 may further include a template adaptation module 116 capable of performing template adaptation through incremental training and to thereby update biometric data stored in the data store 106. As indicated by FIG. 1, performance of a template adaptation process may be depend on whether verification was successful (i.e., that the “Yes” path 112 is followed) and, possibly, one or more additional conditions.

### Template Adaptation

With the described biometric system 100, the claimant's input sample may be compared against the stored biometric data associated with the claimed identity (i.e., the enrollee) during verification. In one embodiment, if the distortion between the claimant's sample and the enrollee's biometric data is less than a threshold (e.g., a predetermined or predefined threshold), then verification may be deemed successful and the claimant may be accepted by the biometric system as the enrollee. On successful verification, the sample input by the now-verified claimant may then be used to adapt the enrollee's biometric data stored in the biometric system in accordance with an adaptation process (which may also referred to as an “incremental training process”).

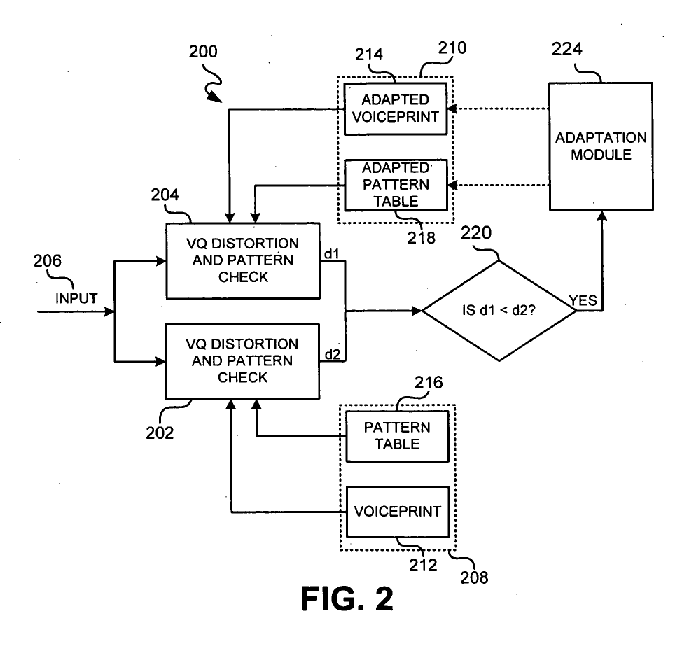

FIG. 2 shows an exemplary architecture 200 for implementing an adaptation process in the context of an illustrative speech-based biometric system (i.e., a speaker recognition system). In this implementation, the biometric system may generate an initial voiceprint from an utterance made by a speaker during enrollment of the speaker with the biometric system. This original voiceprint (which may be referred to as the “base” voiceprint) of the enrollee may be stored “as is” by the biometric system. During subsequent verification sessions where the verification of a claimant is successful (i.e., verification sessions where the claimant is identified as the claimed enrollee), the original voiceprint may be adapted using a new voiceprint generated from the utterance made by the claimant during the verification session. The biometric system may store the voiceprint generated from the claimant's utterance as a voiceprint (which may be referred to as the “adapted” or “tracking” voiceprint) distinct from the original voiceprint. In one embodiment, the adapted voiceprint may comprise a sum of the original voiceprint and an incremental quantity representing change in the speaker's voice between the original voiceprint and the adaptive voiceprint generated from the speech sample input during the verification session.

As shown in FIG. 2, the architecture 200 may include a pair of pattern matching modules 202, 204 for performing pattern matching. In one embodiment, the pattern matching modules 202, 204 may be included as sub-modules of the verification module 102 depicted in FIG. 1. The implemented pattern matching process may be based on techniques known to one of ordinary skill in the art and the pattern matching modules 202, 204 may even be capable of performing one or more pattern matching techniques. In the exemplary implementation shown in FIG. 2, each of the pattern matching modules may be capable of performing patterning matching using vector quantization (VQ) with or without an addition pattern checking technique. Vector quantization may be used to measure differences between the feature vectors acquired from the claimant's speech sample and a voiceprint of an enrollee and output a match score based on the measured differences.

During a verification session, both of the pattern matching modules 202, 204 receive (as input 206) feature vectors extracted from a claimant's speech sample submitted during the verification session. The pattern matching modules 202, 204 may then perform pattern matching on the input feature vectors 206 with pattern matching module 202 comparing the input feature vectors 206 to a base voiceprint 208 of the claimed identity and pattern matching module 204 comparing the input feature vectors 206 to a tracking voiceprint 210 of the claimed identity. The pattern matching process may be carried out for the base voiceprint (i.e., the original voiceprint) and/or the tracking voiceprint.

As previously mentioned, vector quantization may be used to perform these pattern matching comparisons. In such an implementation, the base and tracking voiceprints 208, 210 may each comprise a codebook 212, 214. In an implementation that also performs pattern checking as part of the pattern matching, the base and tracking voiceprints 208, 210 may each also comprise a pattern table 216, 218 that provides a representation of the dynamic behavior of the enrollee's voice. The base voiceprint 208 and/or the tracking voiceprint 210 of an enrollee may be stored in and retrieved from a data store such as the data store 106 depicted in FIG. 1.

As a result of the pattern matching, two separate match scores d1, d2 (which may comprise distortion scores in embodiments using vector quantization) are output from the pattern matching modules 202, 204. In embodiments performing pattern matching using vector quantization (with or without pattern tracking), the output match scores d1, d2 may comprise distortion scores. In any event, match score d1 is output from pattern matching module 204 and represents the amount or degree of dissimilarity between the input feature vectors 206 and the tracking voiceprint 210. Similarly, match score d2 is output from pattern matching module 202 and represents the amount or degree of dissimilarity between the input feature vectors 206 and the base voiceprint 208. In one embodiment, a match score with a low value may be used to indicate a lower degree of dissimilarity between the input feature vectors 206 and the appropriate voiceprint 208, 210 that a match score with a higher value (i.e., the lower the match score value, the more similarity there is).

It should be noted that as an alternative, an implementation may be carried out using a single pattern matching module rather than a pair of pattern matching modules. In such an implementation, the single matching module may perform pattern matching of the input feature vectors twice—once with the base template and once with the tracking template—in order to output both of the distortion values used in the adaptation process.

A decision module 220 may be coupled to pattern matching modules to receive both of the output match scores d1, d2. The decision module 220 may perform a comparison of the match scores d1, d2 in order to determine whether the input feature vectors 206 are a better match to (i.e., more closely match) the tracking voiceprint 210 than to the base voiceprint 208. In the implementation depicted in FIG. 2, the input feature vectors 206 are determined to be a better match to the tracking voiceprint 210 when the value of match score d1 is less than the value of match score d2 (thereby indicating that there is less dissimilarity/more similarity between the input feature vectors 206 and the tracking voiceprint 210 than between the input feature vectors 206 and the base voiceprint 208). If the decision module 220 determines that the input feature vectors 206 more closely matches the tracking voiceprint 210 than the base voiceprint 208, then the decision module 220 may generate an output 222 for invoking an adaptation module 224. In one embodiment, the decision module 220 may limit performance of its comparison of the match scores d1, d2 to those verification sessions in which the claimant is determined to match the claimed identity/enrollee (i.e., the claimant is determined to be genuine). Thus, if the claimant is determined to be an imposter (i.e., the claimant is determined not to match the claimed identity), then the decision module 220 may not perform the comparison of the match scores d1, d2. It should be noted that in one implementation, a successful verification session may require both match scores d1, d2 to be below a decision threshold used to determine whether to accept or reject the claimant.

The adaptation module 224 may be capable of performing an adaptation process for adapting an enrollee's voiceprint to changes in the enrollee's voice over time (e.g., as the enrollee ages). In the implementation shown in FIG. 2, the adaptation module 224 may initiate performance of the adaptation process when invoked by the output 222 generated by the decision module 220. This process may be carried out for both the base voiceprint (i.e., the original voiceprint) and the tracking voiceprint.

### Adaptation Process

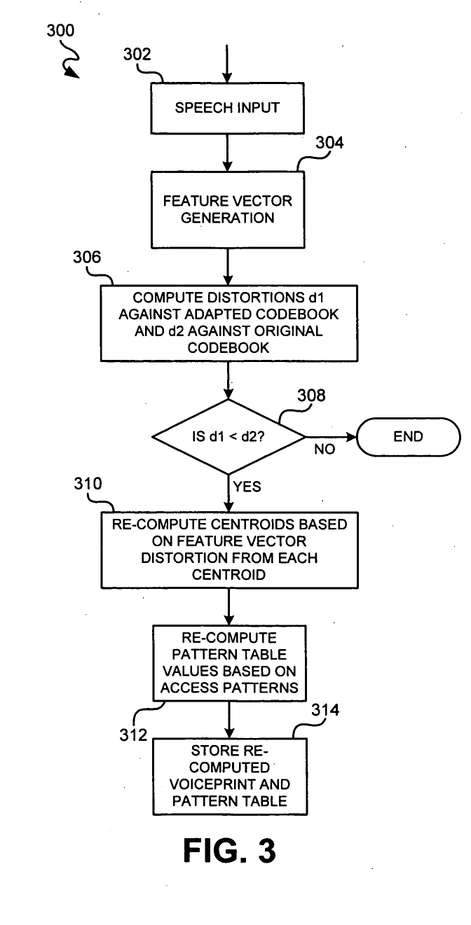

FIG. 3 shows a flowchart 300 of an exemplary adaptation process in the context of a speech-based biometric system implementation. This adaptation process may be performed, for example, using the biometric system 100 and architecture 200 depicted in FIGS. 1 and 2. Utilizing this process, both codebook and the pattern table values may be recomputed after a successful verification.

In operation 302, a biometric sample (e.g., a speech sample such as a spoken utterance) is obtained as input from a claimant (e.g., a speaker) that is claiming to be an enrollee in a biometric system (i.e., a claimed identity). In operation 304, one or more feature vectors are generated from the input biometric sample. Operation 304 may be performed, for example, by the verification module 102 shown in FIG. 1. In a speech based implementation, the feature vectors may be extracted from the input sample using speech processing methods known to one of ordinary skill in the art.

In operation 306, match scores d1 and d2 (which may also be referred to herein as “distortion scores” or simply “distortions”) may be computed between the feature vectors generated from the claimant's sample (from operation 304) and a base template and an adapted template associated with the enrollee with match score d1 being computed using the feature vectors and the base template and match score d2 being computed using the feature vectors and the adaptation template. As indicated by the speech-based implementation shown in FIG. 3, the base and adaptation templates may each comprise codebooks and the match scores may comprise distortion scores or values computed using vector quantization techniques (with or without a pattern check process). Operation 306 may be performed, for example, by pattern matching modules 202 and 204 depicted in FIG. 2.

In decision 308, the match scores d1 and d2 may be used to determine whether the claimant's feature vectors more closely match the adaptation template than the base template. In one embodiment, decision 308 may be performed only if the claimant's identity claim is verified (i.e., the claimant is determined to be genuine). In such an embodiment, decision 308 may be further limited to those verification sessions where the values of both match scores d1 and d2 are found to be within the decision criteria (e.g., below a decision threshold) set by the biometric system for accepting a claimant's claim of identity.

As previously described, the match scores d1, d2 can represent the degree of dissimilarity between the claimant's feature vectors and the corresponding template with a lower match score indicating a greater degree of similarity (i.e., less dissimilarity) between the feature vectors and the given template. Thus, when the value of match score d1 is less than the value of match score d2 (i.e., match score d1<match score d2) indicates that there is more similarity (i.e., less dissimilarity) between the claimant's feature vectors and the adaptation template than between the claimant's feature vectors and the base template. Decision 308 may be performed, for example, by the decision module 220 depicted in FIG. 2.

If the feature vectors are determined not to be more similar to the adaptation template than the base template (i.e., match score d1≧match score d2), then the adaptation process may be ended at decision 308.

On the other hand, if the similarity between the feature vectors and the adaptation template is determined to greater than the similarity between the feature vectors and the base template distortion, then the process may proceed to operation 310 where centroids are recomputed based on the feature vector distortion from each centroid. In one embodiment, the centroids of the adapted template (i.e., the adapted codebook) and/or the base template (i.e., the base codebook) may be recomputed based on the associated feature vector distortion from each respective centroid (e.g., distortion “d1” from the centroid of the adapted template and distortion “d2” from the centroid of the original codebook). Operation 310 may be performed, for example, by the adaptation module 224 depicted in FIG. 2.

If an implementation uses a pattern checking technique when performing pattern matching, then in operation 312, values of a pattern table associated with the enrollee are re-computed based on access patterns for example. Operation 312 may be performed, for example, by the adaptation module 224 depicted in FIG. 2.

In operation 314, the base and adapted templates of the enrollee may be stored (e.g., in data store 106) with the recomputed centroids calculated in operation 310 along with updated versions of the pattern tables (i.e., the base pattern table and the adapted pattern table) recomputed in operation 312 and pattern table recomputed in operation 312.

### Pseudo Code Examples

The following exemplary pseudo code is presented to help further describe the decision making portion of the adaptation process (i.e., operations 302-308) in the context of an exemplary speech based implementation:

```
feature_vector = feature_extraction(input_speech);
distortion 1 = compute_distance(feature_vector, adapted_codebook);
distortion 2 = compute_distance(feature_vector, original_codebook);
if (distortion 1 < distortion 2)
        recompute centroids
        recompute pattern table values
end
```

where:
“input_speech” represents a speech sample input by a claimant;
“feature_extraction” represents speech processing technique(s) for extracting feature vectors from the speech sample “input_speech”;
“feature_vector” represents a feature vector extracted from speech sample “input_speech” using the speech processing technique(s) “feature_extraction”;
“adapted_codebook” represents an vector quantization codebook implementation of an adaptation template of the enrollee whom the claimant claims to be;
“original_codebook” represents an vector quantization codebook implementation of a base template of the enrollee whom the claimant claims to be;
“compute_distance” represents a vector quantization technique for calculating the distance between the feature vector “feature_vector” and a centroid of the given codebook;
“distortion 1” represents the distortion (i.e., match score d1) calculated from feature vector “feature_vector” and a centroid of the adapted template “adapted_codebook” using the technique “compute_distance”;
“distortion 2” represents the distortion (i.e., match score d2) calculated from feature vector “feature_vector” and a centroid of the base template “original_codebook” using the technique “compute_distance”;
“recompute centroids” invokes a process for re-computing the centroids of the base and adapted templates (see operation 312); and
“recompute pattern table values” invokes a process for re-computing the pattern table values associated with the base and adapted templates (see operation 314).

Thus, accordance with the above pseudo code, vector quantization distortions of the claimant's feature vectors are determined against at least one of the adapted and base codebooks. If adapted codebook distortion (distortion 1) is less than the base codebook distortion (distortion 2), then the centroids and pattern table values for the one of the codebooks are re-computed.

The following exemplary pseudo code is presented to help further describe the re-computation portion of the adaptation process (i.e., operations 310 and 312) in the context of an exemplary speech based implementation:

```
distortion = compute_distance(feature_vector, original_codebook);
for j = 1 to codebook_size
      adapted_codebook(j) = original_codebook(j) +
            (confidence_factor) * mean(feature_vector corresponding
            to centroid “j”);
      adapted_pattern_table(j) = pattern_table(j) +
      pattern_factor * new_pattern;
end
```

where:
“feature_vector” represents a feature vector extracted from sample provided by a claimant (now determined to be genuine);
“original_codebook” represents an vector quantization codebook implementation of the base template used in the verification session;
“distortion” represents the distortion calculated from feature vector “feature_vector” and a centroid of the base template “original_codebook” using the technique “compute_distance”;
“codebook_size” represents the number of centroids in the base template
“adapted_codebook(j)” represents an adapted codebook of size “j” (i.e., having j centroids);
“original_codebook(j)” represents a base codebook of size “j” (i.e., having j centroids);
“confidence_factor” represents a value that is computed based on the match score and may depend on the usage environment of the specific implementation;
“mean(feature_vector corresponding to centroid “j”)” represents the mean of the feature vectors with minimum distortions against the corresponding centroids;
“adapted_pattern_table(j)” represents an adapted pattern table associated with adapted_codebook(j);
“pattern_table(j) represents an original or “base” pattern table associated with original_codebook(j);
“pattern_factor” represents a tunable parameter that may be a function of the environment under which the given implementation is used; and
“new_pattern” represents a pattern table calculated the same manner as the base pattern table.

In accordance with the above pseudo code, an enrollee's voiceprint (i.e., template) may be adapted by using the verification utterance made during the successful verification session. The features extracted from the verification utterance are assigned to the different centroids in the codebook depending on the net distortions. The centroid values may then be recomputed. More specifically, each feature vector's distortion is computed against the each codebook entry (i.e., centroid) so that a distortion matrix can be created having entries of all of the feature vectors' distortions from each of the centroids of the codebook. For each entry (i.e., centroid) in the codebook, a modified centroid can then be computed as a sum of the existing centroid and the mean of the feature vectors having the minimum distortions against that particular entry adjusted by (i.e., multiplied by) a confidence factor (e.g., confidence_factor). A similar process may be applied for re-computing the values in the pattern table. The pattern table can be adapted depending on the pattern of the feature vector with the codebook. The adapted pattern table may comprise the sum of the existing pattern table (i.e., the base or original pattern table) and a new pattern (calculated in a similar manner as the original pattern table) adjusted by (i.e., multiplied by) a pattern factor (i.e., pattern_factor).

### Pattern Checking

Pattern checking may be used in a biometric verification system (e.g., a speaker verification system) to help afford a modified vector quantization scheme that may be applicable for use with small-sized biometrics such as, for example, short utterances. This modified vector quantization scheme can help to improve upon traditional vector quantization based verification systems by adding a certain amount of information about the variation of voice in time. A codebook's length (i.e., the amount of entries contained in the codebook) should typically be long enough to accommodate all or most of the distinct characteristics of a given speaker's voice. For long utterances input into a speaker verification system, certain characteristics of a speaker's voice repeat over time and thereby cause multiple references for certain entries in the codebook. On the other hand, most characteristics of a short utterance have been found to be unique. As a result, the occurrence of multiple references for codebook entries may be very little when short utterances are used. Therefore, for a given speaker and utterance, capturing the frequency of reference of codebook entries may result in the capturing of certain temporal properties of a person's voice. During verification, these properties may then be compared (in addition to the standard codebook comparisons).

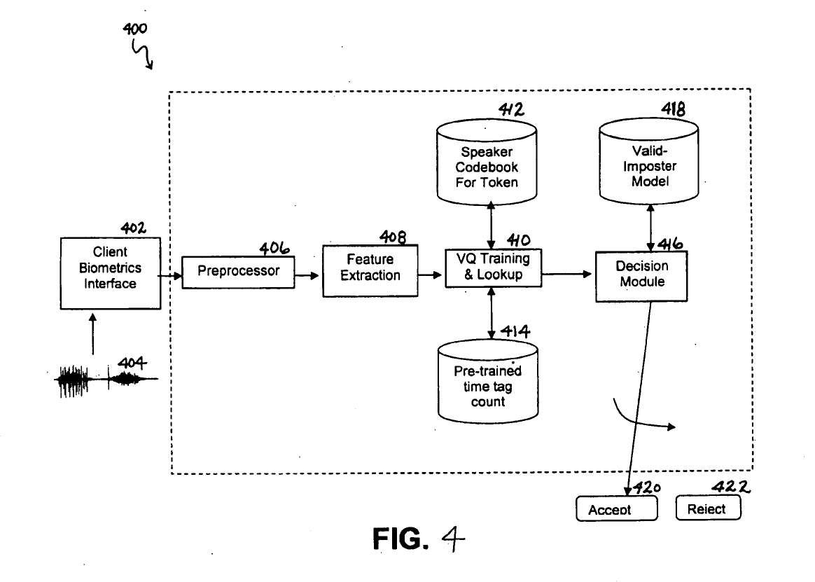

FIG. 4 shows an illustrative verification system architecture 400 for a speaker verification engine. The verification system architecture 400 may include a biometrics interface component 402 for receiving biometric input from a subject (i.e., a speaker). As shown in the implementation of FIG. 4, the biometrics interface component 402 may be adapted for receiving speech input 404 (i.e., sounds or utterances) made by the subject. A pre-processor component 406 may be coupled to the biometric interface component for receiving biometric input(s) 404 captured by the biometric interface component and converting the biometric input into a form usable by biometric applications. An output of the pre-processor component 406 may be coupled to a feature extraction component 408 that receives the converted biometric input from the pre-processor component 406. A training and lookup component 410 (more specifically, a vector quantization training and lookup component) may be coupled to the feature extraction component 408 to permit the training and lookup component 410 to receive data output from the feature extraction component 408. The training and lookup component 410 may be utilized to perform vector quantization and repeating feature vector analysis on the feature vectors extracted from the utterance 404. The training and lookup component 410 may further be coupled to a codebook database 412 (more specifically, a speaker codebook for token database) and a time tag count database 414 (more specifically, a pre-trained time tag count database or a reference log database) to which the training and lookup component 410 may read and/or write data during training and verification. The codebook database 412 and time tag count database 414 may each reside in suitable memory and/or storage devices.

The verification system architecture 400 may further include a decision module/component 416 that may be coupled to the training and lookup component 410 to receive data/information output from the training and lookup component 410. A valid-imposter model database 418 residing in a suitable memory and/or storage device may be coupled to the decision module to permit reading and writing of data to the valid-imposter model database 418. The decision module 416 may utilize data obtained from the training and lookup component 410 and the valid-imposter model database 418 in order to determine whether to issue an acceptance 420 or rejection 422 of the subject associated with the speech input 404 (i.e., decide whether to verify or reject claimed identity of the speaker).

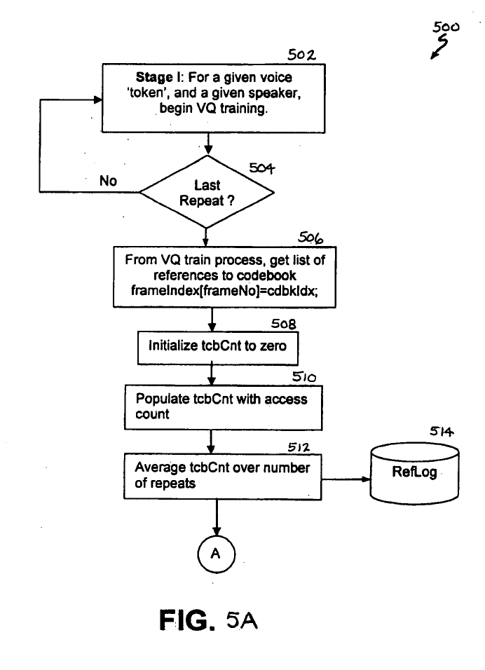

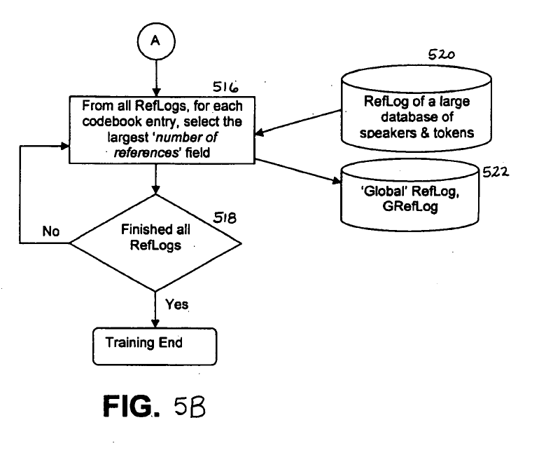

FIGS. 5A and 5B show a flowchart of a vector quantization training process 500 in accordance with one embodiment. In one implementation, the training process 500 may be performed by the training and lookup component 410 described in FIG. 4. Typical speech verification systems typically require the input of a long spoken password or a combination of short utterances in order to successfully carry out speaker verification. In such systems, reduction in the length of spoken password may cause the accuracy of speaker verification to drop significantly. Implementations of the verification system architecture described herein may use a low complexity modified vector quantization technique. These modifications are intended to take into account the variations of voice with time in a fashion similar to dynamic programming (DTW) and HMM while still taking advantage of the lower execution time of vector quantization techniques.

In operation 502, vector quantization training is carried out for a given voice token and a given speaker. The vector quantization training may use any known vector quantization training techniques in order to perform operation 502. For example, the training may utilize a Linde, Buzo, and Gray (LBG) algorithm (also referred to as a LBG design algorithm). The vector quantization training in operation 502 may be repeated for each voice token and speaker until the vector quantization training process is completed for all voice tokens and speakers (see decision 504).

In operation 506, a list of references to a codebook are obtained from the vector quantization training process carried out in operation 502. The list of references to the codebook may comprise a listing of all of the feature vectors occurring in the utterance. As shown in FIG. 5A, operation 506 may utilize the following exemplary pseudo code:
frameIndex[frameNo]=cdbkIdx

where:
“frameIndex” is a map between the speech frames and the codebook entries for all repeats collated end to end;
“frameNo” is a value of between the set {1 . . . Maxframe} and the closest match codebook entry; and
“cdbkIdx” is a value in the set {1 . . . codebook length}.

As set forth in the above pseudo code, the list of references may comprise the frameIndex which maps the feature vectors found in the utterance to the particular frame(s) of the utterance in which each feature vector is found. As an illustrative example, in an utterance comprising frames x, y, and z, and feature vectors a, b, c, and d, the list of reference (i.e., frameIndex) may identify that feature vector a occurs in frame x and frame z, which feature vectors b and c occur in frame y and feature vector d occurs in frame z.

In operation 508, a token cookbook count (“tcbCnt”) is initialized to zero. In operation 510, the token cookbook count is populated with an access count. The access count may reflect the number of occurrences that a given feature vector occurs in the utterance. Continuing with the previous illustrative example, operation 508 would generate an access count of 5 for feature vector a and an access count of 1 for each of feature vectors b, c, and d. An implementation of operation 510 may be further described with the following exemplary pseudo code:

```
for ii=1 to Maxframe
      // increment cb entry access count
      RefLog(i(ii))=RefLog(frameIndex[frameNo])+1;
end
```

The token cookbook count may then be averaged with respect to the number of repeats in operation 212 as illustrated by the following exemplary pseudo code:

// average index over number of repeats
for ii=1 to cdbk_size
RefLog(ii)=RefLog(ii)/numberOfRepeats;
end

Thus, in operation 512, the total number of occurrences of any given feature vector in the utterance may be divided by the total number of repeating occurrences of feature vectors found in the utterance to average the total access count of each feature vector in the frameIndex.

The data obtained in operations 510 and 512 for each token may be stored in a reference log 514 (“RefLog”) that may reside in a memory and/or storage device (e.g., database 414 of FIG. 4). Each token's reference log 514 reflects the number of references by speech frames to each codebook entry. An exemplary format for the reference log 514 is presented in the following table:

| Codebook entry | Number of references (by speech frames) |
|---|---|
| 1 | |
| 2 | |
| . . . | |
| Codebook Size − 1 | |
| Codebook Size | |

As shown in the preceding table, a given token's reference log 514 may include codebook entries (i.e., the left hand column) for an entry equal to one all the way to an entry equal to the codebook size for that particular token. In the right hand column of the illustrative reference log 514, the number of occurrences of a given feature vector in a given feature vector as well as the total number of occurrences of the given feature vector in the utterance may be stored. For example, if the codebook entry “1” in the above table corresponds to the feature vector a from our previous illustrative scenario, then the right hand column of the table may indicate in the row for codebook entry “1” that the feature vector a occurs once in frames x and z for a total of two occurrences in the utterance (i.e., a repeating occurrence of two for feature vector a).

With reference to operation 516 and decision 518, during training, the reference logs for all tokens are combined to generate new reference log that comprises the maximum number of codebook references. Reference logs are obtained from a database 520, having reference logs for a large number of speakers and tokens. For each codebook entry, the largest number of references field is selected from all reference logs and used to populate a global reference log 522 (GRefLog).

An exemplary format for the global reference log database 522 is presented below in the following table (and is similar to the exemplary format for the reference log 514):

| Codebook entry | Number of references (by speech frames) |
|---|---|
| 1 | |
| 2 | |
| . . . | |
| Codebook Size − 1 | |
| Codebook Size | |

As an illustration of the operations 516 and 518, if codebook entry “1” is found to repeat twice in a first reference log, three times in a second reference log, and five times in a third (and last) reference log, then the number of reference entry for codebook entry “1” in the GRefLog would be set to a value of five repeats. Like the RefLog(s), the generated GRefLog may reside in a memory and/or storage device (e.g., database 414 of FIG. 4).

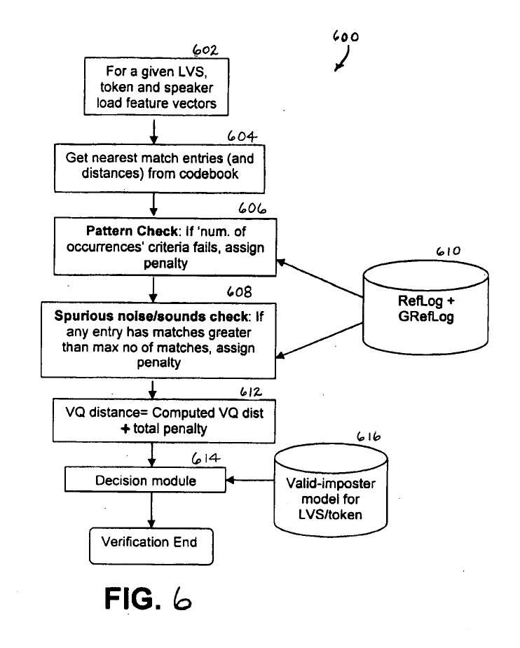

FIG. 6 shows a flowchart for a vector quantization verification process 600 in accordance with one embodiment. With this verification process an utterance of a speaker claiming a particular identity (i.e., a claimant) may be analyzed to determine whether the speaker is in fact the claimed identity. In operation 602, feature vectors may be loaded for a given language vocabulary subset, token and speaker. For these feature vectors, the nearest matching entries may be obtained from a codebook in operation 604. In addition, the distances (i.e., distortion measures) between the feature vectors and matching entries may also be determined in operation 604.

In operation 606, a pattern check may be performed. If criteria relating to the number of occurrences fails, a penalty may be assigned. An implementation of operation 606 may be further described with the following exemplary pseudo code:

```
verifyRefLog=Generate RefLog for verification token;
stg= Total num of references for token from verifyRefLog;
stc= Total num of references for token from RefLog;
sumPenalty=0;
// normalize no. of accesses
fact=stg/stc;
verifyRefLog[1 ... cdbk_size] = verifyRefLog[1 ... cdbk_size]/fact;
// Assign penalty based on difference between verifyRefLog and RefLog
for cb = 1:cdbk_size
      mx=max(verifyRefLog (cb),RefLog(cb));
      mn=min(verifyRefLog (cb),RefLog(cb));
      if(((mx−mn)>= noiseMin) & (mx>=mn*diffFact))
            if((mx−mn)<=validDiff)
                  patDif=(mx-mn)/2;
            else
                  patDif=(mx−mn)*1.5;
            end
            penalty=patDif*eer;
            sumPenalty=sumPenalty+penalty;
      end
end
distance=VQdist+sumPenalty
```

where:
“verifyRefLog” is a RefLog generated from the feature vectors extracted from the utterance made by the claimant. The verifyRefLog may be generated by obtaining information the repeating occurrences of feature vectors in the utterance of the claimant using a similar process as that set forth in operations 206-212 of FIGS. 2A and 2B.
“noiseMin” is the observed variation in the number of references due to natural changes in voice. In the above example, noiseMin is set to a value of 2.
“diffFact” represents factor differences between number of references of RefLog and verifyRefLog. Use of a large value allows larger variations with a person's voice before penalty is applied. Small values cause the reverse effect. In the about example, diffFact is set to a value of 2.
“validDiff” is a value. Differences below this value represent a lower possibility of error (impostor), therefore, a small penalty (50% of difference) is applied. In this example, it is set to 5. Differences above validDiff represent a high possibility of error and a high penalty is assigned (150% of difference). Alternatively, instead of 2 fixed penalties, a continuous relationship between the assigned penalty and the validDiff may be used.
“eer” is an equal error rate that is derived from the operational characteristics of the voice biometrics device.
“distance” is the total distance between incoming speech to the speech from the training sessions. A large distance indicates large difference in speech samples.

The pseudo code for operation 606 describes a pattern match check process. Vector quantization access patterns are stored during enrollment and matched during verification. A penalty is assigned in case of mismatch.

In operation 608, a check for spurious noise and/or sounds may be perform. If any entry is determined to have matches greater than maximum number of matches, then a penalty is assigned. Data relating to the token reference log and the global reference log obtained from a database 610 may be utilized in operations 606 and 608. An implementation of operation 608 may be further described with the following exemplary pseudo code:

```
for cb = 1:cdbk_size
      if(verifyRefLog(cb)>=GRefLog(cb))
            distance=distance + largePenalty;
      end
end
```

where:
“largePenalty” is a value which should be large enough to cause the distance to indicate an impostor. It should also be noted that the noise/spurious sound check may indicate that a voice activity detector (VAD) is not functioning correctly, allowing spurious non-speech frames to pass through. The value of largePenalty may be adjusted to take into account the behavior or the VAD engine used.

The pseudo code for operation 608 describes a spurious sounds/noise check process. The global pattern match table GRefLog indicates the maximum variation in a person's voice. Variations greater than these values would indicate the presence of spurious sounds or noise.

Next, a modified vector quantization distance (i.e., distortion) is determined in operation 612. As shown, in one implementation, the modified vector quantization distance may be calculated by adding (or subtracting) the sum of penalties (if any) assigned in operations 606 and 608 from the standard vector quantization distance(s) calculated in operation 604.

In operation 614, a decision may be made as to whether accept or reject the identity of a claimant using the adjusted vector quantization distance and a valid-imposter model associated with the given language vocabulary subset and/or token. As shown, operation 614 may be performed by a decision module and the valid-imposter model may be obtained from a valid-imposter model database 616.

It should be noted that constants described in the penalty assignment mechanism(s) set forth in the verification process 600 in FIG. 6 represent a certain tradeoff between requirements of security and flexibility. The assigned penalties (i.e., the value of the assigned penalties) may be changed or adjusted to suit different application scenarios.

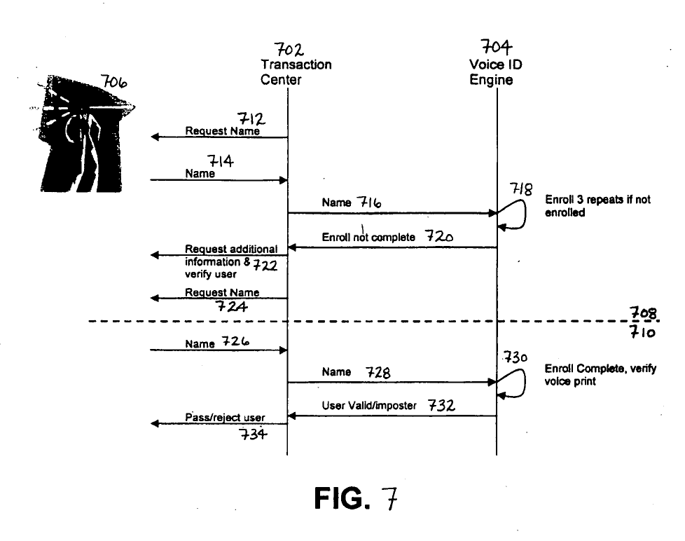

FIG. 7 is a schematic process flow diagram for implementing a verification system architecture in accordance with one embodiment. In this embodiment, a transaction center 702 interfaces with a subject 704 and is in communication with a voice identification engine 706. In this embodiment, vector quantization training 708 may generate a RefLog that may be used in vector quantization verification 710 in order to determine the closeness of incoming speech to the speech from the training sessions.

The transaction center 702 requests that the speaker 706 provide a name and the speaker 706 response by vocally uttering a name that is supposed to be associated with the speaker (see operations 712 and 714). The transaction center 702 captures the speaker's utterance and forwards the captured utterance to the voice identification engine 704 in operation 716. The voice identification engine 704 may instruct the transaction center 702 to request that the speaker 702 repeat the utterance a plurality of times and/or provide additional information if the speaker has not already be enrolled into the verification system (see operations 718 and 720). In response to this instruction, the transaction center 702 requests the appropriate information/utterances from the speaker (see operations 722 and 724). Operations 712-424 may be accomplished utilizing the training process 500 set forth in FIGS. 5A and 5B.

After the speaker 706 has completed the training session 708 and thus enrolled with the verification system, the speaker 706 may subsequently may then be subject to verification 710. In the implementation shown in FIG. 7, the speaker 706 provides the transaction center 702 with an utterance (e.g., a spoken name) that is supposed to be associated with a speaker enrolled with the system (see operation 726). The utterance is captured by the transaction center 702 and forwarded to the voice identification engine 704 in operation 728. In operation 730, the voice identification engine 704 verifies the utterance and transmits the results of the verification (i.e., whether the speaker passes or fails verification) to the transaction center and speaker (see operations 732 and 734). Operations 726-434 may be accomplished utilizing the verification process 600 set forth in FIG. 6.

In accordance with the foregoing description the various pattern checking implementations, verifying the identity of a speaker may be performed as follows. In one embodiment, feature vectors are received that were extracted from an utterance (also referred to as a token) made by a speaker (also referred to as a claimant) claiming a particular identity. Some illustrative examples of feature vectors that may be extracted from an utterance include, cepstrum, pitch, prosody, and microstructure. A codebook associated with the identity may then be accessed that includes feature vectors (also referred to as code words, code vectors, centroids) for a version of the utterance known to be made by the claimed identity (i.e., spoken by the speaker associated with the particular identity that the claimant is now claiming to be).

With this codebook, dissimilarity (it should be understood that the similarity—the converse of dissimilarity—may be measured as well or instead of dissimilarity) may be measured between the extracted feature vectors and the corresponding code words (i.e., feature vectors) of the codebook associated with the version of the utterance known to be made by the claimed identity. The measure of dissimilarity/similarity may also be referred to as a distortion value, a distortion measure and/or a distance.

The utterance may be further analyzed to ascertain information about repeating occurrences (also referred to as repeating instances) for each different feature vector found in the utterance. Through this analysis, information about multiple instances of feature vectors (i.e., repeating instances or repeats) occurring in the utterance may be obtained to generate a reference log for the utterance. That is to say, information about the occurrences of feature vectors occurring two or more times in the utterance may be obtained.

The information about repeating occurrences/instances of feature vectors occurring in the utterance may be compared to information about repeating occurrences/instances of feature vectors in a version of the utterance known to be made by the claimed identity (i.e., code words from the codebook associated with the identity) to identify differences in repeating occurrences of feature vectors between the utterance made by the speaker and the utterance known to be made by the claimed identity. In other words, the obtained information about the occurrence of extracted feature vectors having instances occurring more than once in the utterance may be compared to information about feature vectors occurring more than once in a version (or at least one version) of the utterance known to be made by the claimed identity.

Based on the comparison of the information about repeating occurrences/instances, a penalty may be assigned to the measured dissimilarity (i.e., distortion measure) between the feature vectors and the codebook. Using the measured dissimilarity (i.e., distortion measure) as modified by the assigned penalty, a determination may be made as to whether to accept or reject the speaker as the identity.

In one embodiment, the speaker may be rejected as the claimed identity if the number (i.e., count or value) of repeating occurrences for any of the feature vectors of the utterance exceeds a predetermined maximum number of repeating occurrences and thereby indicates the presence of spurious sounds and/or noise in the utterance. In such an embodiment, an additional penalty may be assigned to the dissimilarity if any of the feature vectors of the utterance by the speaker is determined to have a number of repeating occurrences exceeding the maximum number of repeating occurrences. In one implementation, the additional penalty may be of sufficient size to lead to the rejection the utterance when determining whether to accept/validate the speaker as the claimed identity. In another implementation, the predetermined maximum number for a given feature vector may be obtained by analyzing a plurality of utterances made by a plurality of speakers (i.e., known identities) to identify the utterance of the plurality of utterances having the largest number of repeating occurrences of the given feature vector. In such an implementation, the maximum number may be related and/or equal to the identified largest number of repeating occurrences of the given feature vector. This may be accomplished in one embodiment by identifying all of the utterances in the plurality of utterances having the given feature vector and then analyzing this subset of identified utterances to determine which utterance in the subset has the largest number of repeating occurrences for the given feature vector.

In another embodiment, vector quantization may be utilized to measure dissimilarity between the feature vectors of the utterance by the speaker and the codebook associated with the version of the utterance known to have been made by the identity. In one embodiment, the utterance may a duration between about 0.1 seconds and about 5 seconds. In another embodiment, the utterance may have a duration about between about 1 second and about 3 seconds. In yet another embodiment, the utterance may comprise a multi-syllabic utterance (i.e., the utterance may have multiple syllables). The utterance may also comprise a multi-word utterance (i.e., the utterance may be made up of more than one word).

In one embodiment, the assigned penalty may comprise a separate penalty assigned to each of the different feature vectors of the utterance. The measure (i.e., value or amount) of the assigned penalty for each of the different feature vectors may be based on a difference between a number of repeating occurrences of the respective feature vector of the utterance and a number of repeating occurrences of the corresponding feature vector of the version of the utterance know to be made by the identity.

In one implementation, the value of the assigned penalty for given feature vector may be adjusted based on the degree of difference between the number of repeating occurrences of the respective feature vector of the utterance and the number of repeating occurrences of the corresponding feature vector of the version of the utterance know to be made by the identity. In a further implementation, the value of the assigned penalty for each different feature vector may be adjusted to account for operational characteristics of a device used to capture the utterance by the speaker.

In yet another implementation, no penalty may be assigned to a given feature vector if the difference between the number of repeating occurrences of the respective feature vector of the utterance and the number of repeating occurrences of the corresponding feature vector of the version of the utterance know to be made by the identity is determined to be less than an expected difference of repeating occurrences occurring due to expected (i.e., natural) changes in a speaker's voice that may occur when making utterance at different times. In an additional implementation, the value of the assigned penalty for a given feature vector may be reduced if the difference between the number of repeating occurrences of the respective feature vector of the utterance and the number of repeating occurrences of the corresponding feature vector of the version of the utterance know to be made by the identity is determined to be less than a predefined value below which represents a lower possible of error for an incorrect acceptance of the given feature vector as that made by the identity.

In an additional embodiment, the measured dissimilarity (i.e., distortion measure) as modified by the assigned penalty may be compared to a valid-imposter model associated with the utterance when the determining whether to accept or reject the speaker as the identity. In a further embodiment, the utterance may comprise a plurality of frames. In such an embodiment, the analysis of the utterance to ascertain information about repeating occurrences/instances of the feature vectors in the utterance may include identifying the feature vectors occurring in each frame, counting the instances that each different feature vector of the utterance occurs in all of the frames to obtain a sum of repeating occurrences of each feature vector, and averaging the sums by dividing each sum by a total number of repeating occurrences occurring in the utterance.

In one embodiment, a speaker verification system may be trained by obtaining an utterance that comprises a plurality of frames and has a plurality of feature vectors. In such an embodiment, the feature vectors present in each frame may be identified and the presence of feature vectors by frame for the whole utterance may be tabulated. Next, the number of instances each feature vector is repeated in the utterance may be identified from which a total sum of all repeating instances in the utterance may be calculated. The number of repeats for each feature vector may then be divided by the total sum to obtain an averaged value for each feature vector and the information about the number of repeats for each feature vector may be stored in a reference log associated with the utterance. In one implementation, the reference logs of a plurality of utterances made by a plurality of speakers may be examined to identify a set of feature vectors comprising all of the different feature vectors present in the reference logs. For each different feature vector, the largest number of repeat instances for that feature vector in a single reference log may then be identified and a global reference log may be generated that indicates the largest number of repeat instances for every feature vector.

For purposes of the various embodiments described herein, an utterance may be isolated words or phrases and may also be connected or continuous speech. In accordance with one embodiment, a short utterance for purposes of implementation may be considered an utterance having a duration less than about four seconds and preferably up to about three seconds. A short utterance may also be multi-syllabic and/or comprise a short phrase (i.e., a plurality of separate words with short spaces between the words).

A language vocabulary subset may comprise a logical or descriptive subset of the vocabulary of a given language (e.g., English, German, French, Mandarin, etc.). An illustrative language vocabulary subset may comprise, for example, the integers 1 through 10. A token may be defined as an utterance made by a speaker. Thus, in the illustrative language vocabulary subset, a first token may comprise the utterance “one”, a second token may comprise the utterance “two,” and so up to a tenth token for the utterance “ten.”

In embodiments of the speaker verification system architecture, a time tag count field may be included with each entry of a codebook. Once trained and populated, the codebook may be subjected to a second round of training.

It should be understood that like terms found in the various previously described pseudo codes may be similarly defined, unless noted in the respective pseudo code.

Accordingly, implementations of the present speaker verification system architecture may help to improve traditional vector quantization systems by taking into account temporal information in a persons voice for short utterances and reducing the affect of background noise. Embodiments of the present invention may help to reduce the cost of implementing speaker verification systems while providing comparable verification accuracy to existing speaker verification solutions. In addition, embodiments of the speaker verification system architecture described herein may help to reduce the time for performing enrollment into the verification system as well as the time needed to perform verification. The implementation cost of the speaker verification system architecture may be lowered by improving the execution speed of the algorithm. The speaker verification system architecture may use a low complexity modified vector quantization techniques for data classification. With the present speaker verification system architecture, short voiced utterances may be used for reliable enrollment and verification without reduction in verification accuracy. Short voiced utterances and reduced execution time helps to quicken enrollment and verification times and therefore reduces the amount of time that a user has to spend during enrollment and verification. Embodiments of the present speaker verification system architecture may also help to afford noise robustness without the use of elaborate noise suppression hardware and software.

### Representative Environment

Embodiments of the biometric system described herein may be used to implement security or convenience features (e.g. a personal zone configuration) for resource-constrained products such as, for example, like personal computers, personal digital assistants (PDAs), cell phones, navigation systems (e.g., GPS), environmental control panel, and so on. Embodiments of the verification system architecture may be implemented in non-intrusive applications such as in a transaction system where a person's spoken name may be used (or is typically used) to identify the person including implementations where the person's identity may be verified without the person being aware that the verification process is going on.

In accordance with the foregoing description, updating a biometric model (e.g., a template, codebook, pattern table, etc.) of a user enrolled in a biometric system (i.e., an enrollee) based on changes in a biometric feature of the user may be performed as follows. In accordance with one embodiment, this process may begin when a user (i.e., a claimant) is authenticated (i.e., successfully verifying) in a biometric system based on an analysis of a biometric sample.(i.e., a “first” biometric sample) received from the user during a verification session. In this process, features vectors extracted from the first biometric sample are compared both to a first model (i.e., a base or original model/template/codebook) generated (i.e., created) using an initial biometric sample (i.e., a “second biometric sample) obtained from the user at enrollment in the biometric system as well as to a second model (i.e., a tracking or adaptive model/template/codebook) generated using a previously authenticated biometric sample obtained from earlier successful verification session (i.e., a “third biometric sample. These comparisons are performed to determine whether the feature vectors more closely match the tracking model than the base model. In other words, to determine whether there is more similarity (i.e., less dissimilarity) between the extracted features and the tracking model than between the extracted features and the base model. If the features more closely match the tracking model than the base model, then the base and tracking models may be updated based on the extracted features obtained from the user during this verification session.

Embodiments of this process may be implemented in a speech verification system where the biometric samples are speech samples (i.e., utterances) made by the user. These embodiments can even be implemented in systems where each utterance are short, for example, having a duration between about 0.1 seconds and about 5 seconds. Embodiments may also be implemented using vector quantization techniques with the models comprising vector quantization codebooks. For example, embodiments may be implemented for updating a codebook of a user enrolled in a speaker verification system based on changes in the voice of the user over time. In such implementations, the authenticating of the speaker can be based on an analysis of a speech sample received from the speaker during a verification session. The feature vectors extracted from the speech sample can be compared to an original codebook created from an initial speech sample obtained at enrollment of the speaker in the speaker verification system and a tracking codebook computed using a previously authenticated speech sample obtained from a previous verification session. From this comparison, it may be determined whether the feature vectors more closely match the tracking codebook than the original template. If the features more closely match the second template than the first template, then the centroids of the codebooks can be recalculated using the extracted features in order to update the codebooks.

In another embodiment, the updated models can be stored in a data store. In further embodiment, the updating can include applying a confidence factor to the models. In one embodiment, the updating may include re-computing centroids of the first and second models based on distortions of the features from each centroid.

In one embodiment, the comparing may include comparing distortion calculated between the features and the first model to the distortion calculated between the features and the second model. In such an embodiment, the distortions can be calculated during the authenticating of the user.

In accordance with a further embodiment, the comparing may involve measuring dissimilarity between the features and the first model and dissimilarity between the features and the second model. The first biometric sample may also be analyzed to ascertain information about repeating occurrences of the features in the first biometric sample. For example, in a speech-based implementation, an utterance can be analyzed to ascertain information about repeating occurrences of the feature vectors in the utterance. The information about repeating occurrences of features occurring in the first biometric sample may then be compared with information about repeating occurrences of the features in at least one previous version of the biometric sample known to have been made by the user. Continuing the previous speech-based exemplary implementation, the information about repeating occurrences of feature vectors occurring in the utterance can be compared, for example, to information about repeating occurrences of feature vectors in a version of the utterance known to be made by the claimed identity. Based on the comparison of repeating occurrences, a penalty may be assigned to the measured dissimilarity. In such an implementation, the updating of the models may further include adjusting the information about repeating occurrences of the features in at least one previous version of the biometric sample known to have been made by the user by a factor based on the information about repeating occurrences of the features in the first biometric sample.

The various embodiments described herein may further be implemented using computer programming or engineering techniques including computer software, firmware, hardware or any combination or subset thereof. While components set forth herein may be described as having various sub-components, the various sub-components may also be considered components of the system. For example, particular software modules executed on any component of the system may also be considered components of the system. In addition, embodiments or components thereof may be implemented on computers having a central processing unit such as a microprocessor, and a number of other units interconnected via a bus. Such computers may also include Random Access Memory (RAM), Read Only Memory (ROM), an I/O adapter for connecting peripheral devices such as, for example, disk storage units and printers to the bus, a user interface adapter for connecting various user interface devices such as, for example, a keyboard, a mouse, a speaker, a microphone, and/or other user interface devices such as a touch screen or a digital camera to the bus, a communication adapter for connecting the computer to a communication network (e.g., a data processing network) and a display adapter for connecting the bus to a display device. The computer may utilize an operating system such as, for example, a Microsoft Windows operating system (O/S), a Macintosh O/S, a Linux O/S and/or a UNIX O/S. Those of ordinary skill in the art will appreciate that embodiments may also be implemented on platforms and operating systems other than those mentioned. One of ordinary skilled in the art will also be able to combine software with appropriate general purpose or special purpose computer hardware to create a computer system or computer sub-system for implementing various embodiments described herein. It should be understood the use of the term logic may be defined as hardware and/or software components capable of performing/executing sequence(s) of functions. Thus, logic may comprise computer hardware, circuitry (or circuit elements) and/or software or any combination thereof.

Embodiments of the present invention may also be implemented using computer program languages such as, for example, ActiveX , Java, C, and the C++ language and utilize object oriented programming methodology. Any such resulting program, having computer-readable code, may be embodied or provided within one or more computer-readable media, thereby making a computer program product (i.e., an article of manufacture). The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

Based on the foregoing specification, embodiments of the invention may be implemented using computer programming or engineering techniques including computer software, firmware, hardware or any combination or subset thereof. Any such resulting program—having computer-readable code—may be embodied or provided in one or more computer-readable media, thereby making a computer program product (i.e., an article of manufacture) implementation of one or more embodiments described herein. The computer readable media may be, for instance, a fixed drive (e.g., a hard drive), diskette, optical disk, magnetic tape, semiconductor memory such as for example, read-only memory (ROM), flash-type memory, etc., and/or any transmitting/receiving medium such as the Internet and/or other communication network or link. The article of manufacture containing the computer code may be made and/or used by executing the code directly from one medium, by copying the code from one medium to another medium, and/or by transmitting the code over a network. In addition, one of ordinary skill in the art of computer science may be able to combine the software created as described with appropriate general purpose or special purpose computer hardware to create a computer system or computer sub-system embodying embodiments or portions thereof described herein.

While various embodiments have been described, they have been presented by way of example only, and not limitation. In particular, while many of the embodiments described are described in an speech-based implementation, it should be understood to one of ordinary skill in the art that it may be possible to implement embodiments described herein using other biometric features and behaviors such as, for example, fingerprint, iris, facial and other physical characteristics, and even handwriting. Thus, the breadth and scope of any embodiment should not be limited by any of the above described exemplary embodiments, but should be defined only in accordance with the following claims and their equivalents.

1. A method, comprising:
authenticating a user based on an analysis of a first biometric sample received from the user;
comparing features extracted from the first biometric sample to a first model generated using a second biometric sample obtained from the user at enrollment and a second model generated using a previously authenticated third biometric sample to determine whether the features more closely match the second model than the first model; and
updating the first and second models based on the extracted features if the features more closely match the second model than the first model.

2. The method of claim 1, wherein the biometric samples comprise speech.

3. The method of claim 1, wherein the models each comprise a codebook and the comparing is performed utilizing vector quantization.

4. The method of claim 1, wherein the updated models are stored in a data store.

5. The method of claim 1, wherein the comparing includes comparing first distortion calculated between the features and the first model to second distortion calculated between the features and the second model.

6. The method of claim 5, wherein the distortions are calculated during the authenticating of the user.

7. The method of claim 1, wherein the updating includes re-computing centroids of the first and second models based on distortions of the features from each centroid.

8. The method of claim 1, wherein the updating includes applying a confidence factor to the models.

9. The method of claim 1, wherein the comparing comprises
measuring dissimilarity between the features and the first model and dissimilarity between the features and the second model;
analyzing the first biometric sample to ascertain information about repeating occurrences of the features in the first biometric sample;
comparing the information about repeating occurrences of features occurring in the first biometric sample with information about repeating occurrences of the features in at least one previous version of the biometric sample known to have been made by the user; and
assigning a penalty to the measured dissimilarity based on the comparison of repeating occurrences.

10. The method of claim 9, wherein the updating includes adjusting the information about repeating occurrences of the features in the at least one previous version of the biometric sample known to have been made by the user by a factor based on the information about repeating occurrences of the features in the first biometric sample.

11. A system, comprising:
a verification module for receiving a first biometric sample from a user and authenticating the user based on an analysis of the first biometric sample;
a decision module for comparing features extracted from the first biometric sample to a first model generated using a second biometric sample obtained from the user at enrollment and a second model generated using a previously authenticated third biometric sample to determine whether the features more closely match the second model than the first model; and
an adaptation module for updating the first and second models based on the extracted features if the features more closely match the second model than the first model.

12. The system of claim 11, wherein the biometric samples comprise speech.

13. The system of claim 11, wherein the models each comprise a codebook and the comparing is performed utilizing vector quantization.

14. The system of claim 11, wherein the updated models are stored in a data store.

15. The system of claim 11, wherein the comparing includes comparing first distortion calculated between the features and the first model to second distortion calculated between the features and the second model.

16. The system of claim 11, wherein the updating includes re-computing centroids of the first and second models based on distortions of the features from each centroid.

17. The system of claim 11, wherein the updating includes applying a confidence factor to the models.

18. The system of claim 11, wherein the comparing comprises
measuring dissimilarity between the features and the first model and dissimilarity between the features and the second model;
analyzing the first biometric sample to ascertain information about repeating occurrences of the features in the first biometric sample;
comparing the information about repeating occurrences of features occurring in the first biometric sample with information about repeating occurrences of the features in at least one previous version of the biometric sample known to have been made by the user; and
assigning a penalty to the measured dissimilarity based on the comparison of repeating occurrences.

19. The system of claim 18, wherein the updating includes adjusting the information about repeating occurrences of the features in the at least one previous version of the biometric sample known to have been made by the user by a factor based on the information about repeating occurrences of the features in the first biometric sample.

20. A computer program product capable of being read by a computer, comprising:
computer code for authenticating a user based on an analysis of a first biometric sample received from the user;
computer code for comparing features extracted from the first biometric sample to a first model generated using a second biometric sample obtained from the user at enrollment and a second model generated using a previously authenticated third biometric sample to determine whether the features more closely match the second model than the first model; and
computer code for updating the first and second models based on the extracted features if the features more closely match the second model than the first model.
